(19) United States
(12) Patent Application Publication
(10) Pub. No.: US 2010/0235144 A1
(43) Pub. Date: Sep. 16, 2010

(54) Method and system for automated monitoring of the production and/or consumption of meterable substances or thermodynamically quantifiable entities, including power and energy

(76) Inventor: David Mosberger-Tang, Boulder, CO (US)

Correspondence Address: OLYMPIC PATENT WORKS PLLC, P.O. BOX 4277, SEATTLE, WA, 98104, US

(21) Appl. No.: 12/386,928

(22) Filed: Apr. 24, 2009

Related U.S. Application Data
(60) Provisional application No. 61/047,521, filed on Apr. 24, 2008.

(51) Int. Cl. G06F 15/00; G06F 17/30; G06F 3/048; G06F 15/16

(52) U.S. Cl. 702/188; 707/802; 715/771; 709/219; 707/E17.044

(57) ABSTRACT

Embodiments of the present invention are directed to automated metering and monitoring systems that monitor consumption and production of various consumables, such as electrical power, gas, water, and other such consumables, within physical sites and locations as well as within more abstractly defined and specified regions. The automated metering and monitoring systems of the present invention record production and consumption data, over time, at high granularities or, in other words, at short time intervals, so that near-continuous consumption and production of consumables can be recorded, transmitted, processed, and displayed for arbitrarily-selected time intervals. In certain embodiments of the present invention, monitoring data is collected and stored, at intervals of minutes, seconds, or fractions of seconds, in electrical memory and transmitted, through the Internet or other data-transmission media, to remote computers on which the data is processed for storage, analysis, and/or graphical display to users.

### CROSS REFERENCE TO RELATED APPLICATION

This application claims the benefit of Provisional Application No. 61/047,521, filed Apr. 24, 2008.

### TECHNICAL FIELD

The present invention is related to monitoring the production and consumption of various types of quantities and substances, including the production and consumption of power, energy, water, gas, and other such consumables and, in particular, to automated monitoring of production and consumption within physical installations, physical locations, or geographical regions or more abstractly defined regions and locations, with monitoring-data collection and transmission to remote locations for processing and for providing a graphical display of, as one example, the production and consumption history of the various consumables for specified periods of time.

### BACKGROUND OF THE INVENTION

Currently, a variety of different types of consumables providers monitor both the production and consumption of consumables, such as electrical power, natural gas, water, and other consumables, using electromechanical meters. Commonly, utilities send human meter-data collectors out to remote locations in order to read and collect meter data, which are returned to centralized locations where billing statements and simple, numeric consumption data are compiled and sent to consumers. While generally effective, these current methodologies are expensive and collect information at rather large time intervals. Such widely-spaced data points omit a large amount of potentially useful monitoring information that could be used both by utilities and by consumers. Furthermore, with the advent of on-site generation of consumables by consumers who may output on-site-generated consumables to utilities for use by other consumers, monitoring of both production and consumption may be required, complicating the metering and meter-data collection tasks. The manually collected and compiled monitoring data may be difficult to process in order to extract higher-level information concerning patterns of consumption and production of consumables over various periods of time, in arbitrarily defined regions, and partitioned and compiled in alternative fashions to show other aspects of production and consumption. For all of these reasons, designers and manufacturers of metering systems, producers and consumers of energy and other metered substances and quantities, and various utilities and services all continue to seek improved automated metering and monitoring systems that to collect, store, transmit, and process monitoring data to provide meaningful monitoring-data presentation to users, including users within utilities and service providers as well as individual consumers and producers of consumables and groups of consumers and producers.

### SUMMARY OF THE INVENTION

Embodiments of the present invention are directed to automated metering and monitoring systems that monitor consumption and production of various consumables, such as electrical power, gas, water, and other such consumables, within physical sites and locations as well as within more abstractly defined and specified regions. The automated metering and monitoring systems of the present invention record production and consumption data, over time, at high granularities or, in other words, at short time intervals, so that near-continuous consumption and production of consumables can be recorded, transmitted, processed, and displayed for arbitrarily selected time intervals. In certain embodiments of the present invention, monitoring data is collected and stored, at intervals of minutes, seconds, or fractions of seconds, in electrical memory and transmitted, through the Internet or other data-transmission media, to remote computers on which the data is processed for storage, analysis, and/or graphical display to users.

### BRIEF DESCRIPTION OF THE DRAWINGS

FIG. 1 is a system-diagram of a typical eGauge installation according to one embodiment of the present invention.

FIG. 2 shows a graphical display of power consumption and power generation rendered by a graphical web browser connected to the web server running on eGauge, according to one embodiment of the present invention.

FIG. 3 is a diagram of the hardware implementation of one embodiment of the present invention.

FIG. 4 shows a voltage probe used in embodiments of the present invention.

FIG. 5 shows a current probe used in embodiments of the present invention.

FIG. 6 is a high-level diagram showing remote access to eGauge according to one embodiment of the present invention.

FIG. 7 shows a diagram of the software running on the eGauge hardware according to one embodiment of the present invention.

FIG. 8 illustrates linear interpolation of measurement across multiple rising zero-crossings according to one embodiment of the present invention.

FIG. 9 illustrates linear interpolation to interpolate the voltage at the point when a current sample was taken according to one embodiment of the present invention.

FIG. 10 illustrates an example of the contents and format of the configuration file according to one embodiment of the present invention.

FIG. 11 illustrates a hierarchical and cyclical database design used in certain embodiments of the present invention.

FIG. 12 illustrates an XML format in which DbReader returns data to the web server according to one embodiment of the present invention.

FIG. 13 illustrates the XML format in which ShmReader returns data to the web server according to one embodiment of the present invention.

FIG. 14 shows a Google Gadget that can be added to a customized iGoogle home page according to one embodiment of the present invention.

FIG. 15 illustrates running a proxy server on a third-party computer according to one embodiment of the present invention.

FIG. 16 shows the list returned in an XML-format.

### DETAILED DESCRIPTION OF THE INVENTION

Embodiments of the present invention are directed to monitoring systems for monitoring the amount of various quantities and substances input to, and output from, physical sites, regions, or groups of sites and regions, and for collecting, storing, transmitting, processing, and, ultimately, displaying the monitoring data. In the following discussion, monitoring systems for monitoring electrical power consumption and production in physical sites are discussed, in detail, as a representative embodiment of the present invention. However, the production and consumption of many other types of consumables, within arbitrarily defined locations, are subjects for monitoring by many alternative embodiments of the present invention, including thermodynamically quantifiable consumables such as electric power or energy. The term “consumable” is used, in the following discussion, to mean a meterable and/or monitorable substance, such as gas or water, or a thermodynamically quantifiable entity, such as power, energy, and other such thermodynamically quantifiable entities that can be metered and/or monitored.

One embodiment of the present invention is referred to as “eGauge,” and is a software-defined energy and power monitor. One embodiment of eGauge performs the following functions:
1. eGauge samples the voltages and currents on a configuration-specific number of channels. Typically, there are at least two voltage channels, at least two current channels, and the channels are sampled at least 600 times per second.
2. From the sampled values, eGauge calculates true RMS voltage, RMS current, power factor, mean (real) power, and energy usage in a configuration-specific manner.
3. To minimize data loss in the event of a power failure, eGauge frequently stores the current energy values in non-volatile RAM (typically once a second).
4. Periodically, for example, once a minute, eGauge logs some or all of the calculated values to non-volatile memory, such as flash memory. The non-volatile memory typically is large enough to record several years' worth of data. For example, in one configuration, eGauge can store 80 years' worth of daily data, 32 years' worth of hourly data, and 32 weeks' worth of minute-by-minute data. The data-storage capacities of even low-end implementations of eGauge are expected to significantly increase, over time, as electronic memories continue to relentlessly decrease in price and increase in density.
5. eGauge contains a web server which provides:
   (a) Access to the recorded data. Optionally, this data may be protected so that only authorized users can access the data. In one eGauge implementation, the data is provided to a requestor either in a low-level XML format, in user-friendly graphical fashion, or both.
   (b) Access to statistics computed from the recorded data. For example, average number of sunshine hours on a monthly basis; maximum power generated/used; average power generated/used. The statistics may be computed on the fly or pre-computed and stored in non-volatile memory.
   (c) Access to the eGauge configuration so that the device can be configured, tuned, and otherwise adjusted to the local environment.
   (d) A remote upgrade facility so that the eGauge software can be updated remotely and conveniently, without requiring physical access to the device.
6. In order to automatically maintain current time, one embodiment of eGauge runs a network-time-protocol daemon which synchronizes with atomic precision clocks available on the Internet, such as the clocks available at pool.ntp.org. When Internet connectivity is unavailable, time can also be synchronized with an on-board real-time clock (“RTC”).
7. One implementation of eGauge is configured to establish and maintain a network connection with a configuration-specific proxy server to enable indirect remote access for environments where eGauge is not directly accessible from the Internet, such as when eGauge is installed behind a firewall.
8. One implementation of eGauge is configured to register the public IP address through which it is connected to the Internet with a designated server. This enables remote accessibility and remote maintenance.
   The described embodiment of eGauge is software defined in the sense that it uses generic hardware to sample voltage and current signals. Power and energy calculations are carried out under software control on a general-purpose CPU. In other words, the hardware itself is not fixed to a single purpose. It could be used for other applications such as, for example, a software-defined voltage or current oscilloscope or for a spectrum analyzer. The described embodiment of eGauge is a combined hardware and software device that can be used as a versatile power and energy monitor and that, when coupled to a remote data-collection and data-processing system, can be used in a distributed monitoring system that provides both individual site and regional monitoring of power production and consumption.

The described embodiment of eGauge leverages a fast, yet low-power, CPU for many tasks: power measurements on several channels, logging data, and serving data, via a web server, to remote computers and systems. Use of a fast, but low-power, CPU provides for a low-cost and versatile monitoring device. The described embodiment of eGauge effectively employs a low-power general purpose computer to run a web server and to perform power measurements.

### Overview

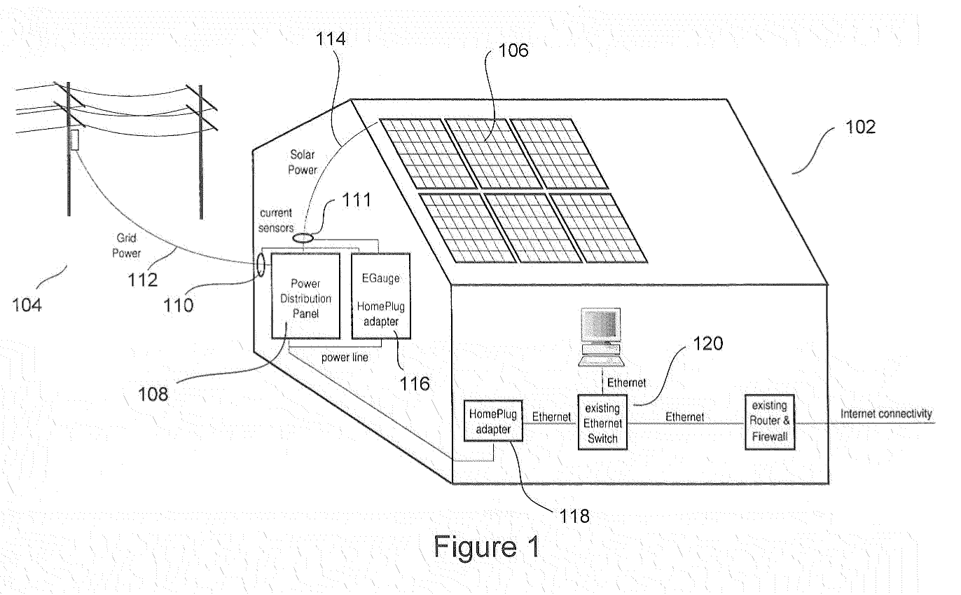

FIG. 1 is a system diagram of a typical eGauge installation according to one embodiment of the present invention. In this example, eGauge is used to measure the electric power consumption in a house. The house 102 receives power from two sources: a utility's power grid 104 and a local array of solar panels 106. The locally generated power is first used to satisfy any power consumption within the house. Excess electrical power produced by the solar panels is fed back into the grid. In this example, net metering is in effect, where the utility's energy meter measures the net electricity consumed or generated by the house.

As shown in FIG. 1, eGauge typically would be installed either inside or near the power distribution panel 109. To measure the power supplied by the grid and the local solar system, current sensors 110-111 are installed around the power lines that feed the distribution panel. Each power line also generally is associated with a voltage sensor that measures the instantaneous voltage present on the power line. For simplicity, FIG. 1 shows only a single line 112 and 114 for each power source. In reality, most residences in the US receive power via a split-power distribution system, which essentially provides two phases at 120V/60 Hz each. Commercial customers typically are connected to the grid through a three-phase power distribution system. eGauge generally measures each voltage and current separately. Thus, assuming split-power distribution, eGauge for the system shown in FIG. 1 would actually measure two voltages (phase A and phase B) and four currents (phase A and B from the grid and phase A and B from the solar system).

FIG. 1 also shows that eGauge has a built-in HomePlug adapter 116. This HomePlug adapter converts an Ethernet signal into signals that are transmitted over the power lines inside the house. By plugging a second HomePlug adapter 118 into any outlet inside the house and connecting that second adapter to a local network (LAN) 120, it is then possible for any computer on the LAN to access eGauge. Furthermore, if the LAN is attached to a router/firewall and the firewall is configured to allow access, it is also possible to access eGauge remotely from a remote Internet site.

eGauge is not limited to HomePlug connectivity. Alternatively, eGauge can also be connected to the LAN directly via an Ethernet cable, via a WiFi adapter, via a USB cable, other types of power line adapters, or even via a plain serial cable. In essence, any connectivity that can run the Internet protocol (“IP”) at reasonably high speed (at least 128 Kbps) can be used.

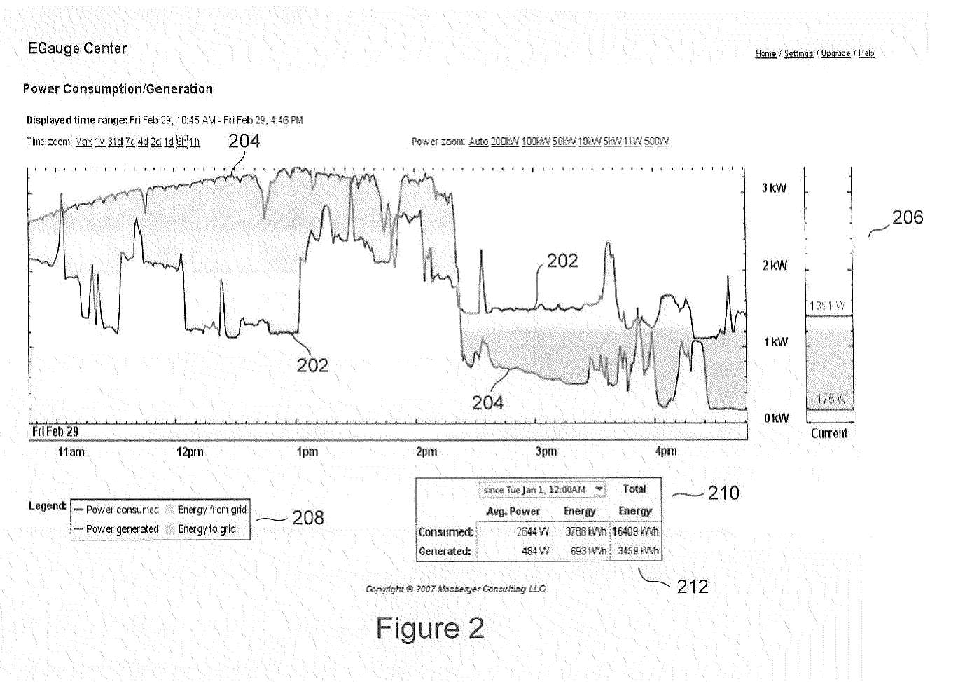

In certain embodiments of the eGauge, eGauge interfaces to other devices and computers through the network interface. FIG. 2 shows a graphical display of power consumption and power generation rendered by a graphical web browser connected to the web server running on eGauge, according to one embodiment of the present invention. In this example the graphical display shows power consumption (curve 202) and power generation (curve 204) over a six-hour period starting February 29 at 10:45 am. As time passes, the graphs are automatically updated once a minute. To the right of the graphs a gauge 206 displays the current power consumption and generation (updated every second). Below the graphs a legend describing color coding of the curves and areas in the graphs 208 and, to the right of the legend, statistical information is displayed in a table 210. In the example shown in FIG. 2, the table displays the average power and energy used/generated at any given point in time during the period beginning on January 1st, and the right-most column 212 displays the total energy used/generated during that time period.

### Hardware

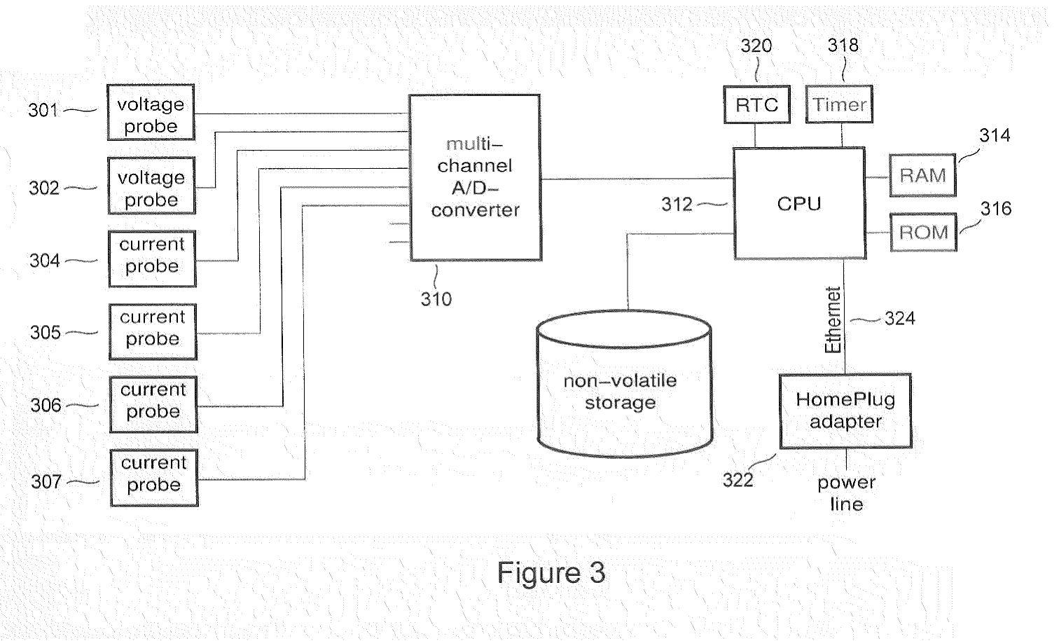

FIG. 3 is a diagram of the hardware implementation of one embodiment of the present invention. Several voltage probes 301-302 and several current probes 304-307 are shown in FIG. 3. Normally there is one voltage probe per phase, one current probe per phase, and one current probe per power source. For example, in a residence with a typical split-phase connection to the grid and a single solar system, there are two voltage probes (one per split phase) and four current probes (two to measure the current on each phase from/to the grid and two to measure the current on each phase from/to the solar system). More probes are used, for example, in a commercial installation with three phases or when the solar system has multiple inverters and it is desirable to measure the power of each inverter separately. Conversely, fewer probes may be needed, for example, in residences with a single-phase grid connection or residences without a solar system.

Each probe connects to one channel of a multi-channel analog-to-digital converter (“ADC”) 310. In systems with large numbers of probes, multiple ADCs may be needed to accommodate all probes. The ADC is, in turn, connected to a CPU 312. The CPU performs its functions with the help of a random-access memory (RAM) 314, read-only memory (ROM) 316, non-volatile storage (typically a solid-state flash-memory card), a high-resolution timer 318, and a battery-backed non-volatile RAM with a real-time clock (“RTC”) 320. Note that the system can accommodate an arbitrary number of voltage and current probes, limited only by the speed of the CPU The external interface is provided via a HomePlug adapter 322 which is connected to the CPU via an Ethernet interface 324. The HomePlug modulates the Ethernet data onto a power line, which then allows decoding of the original Ethernet data at any power outlet in the building.

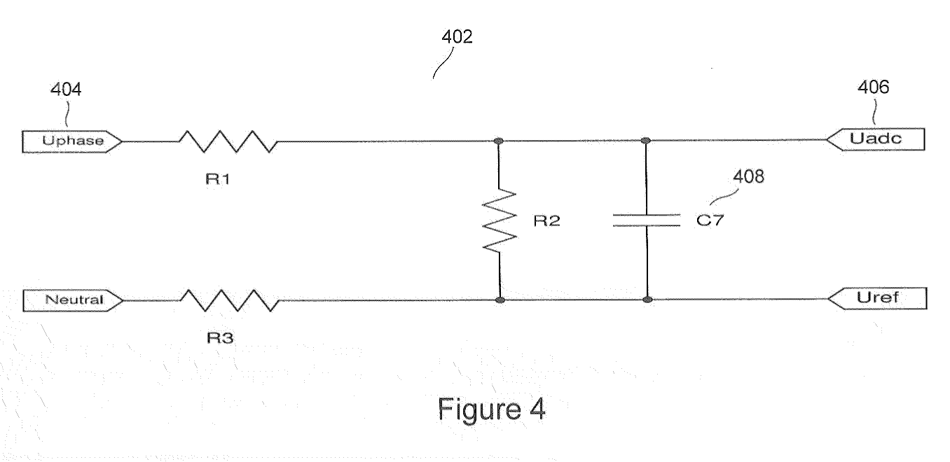

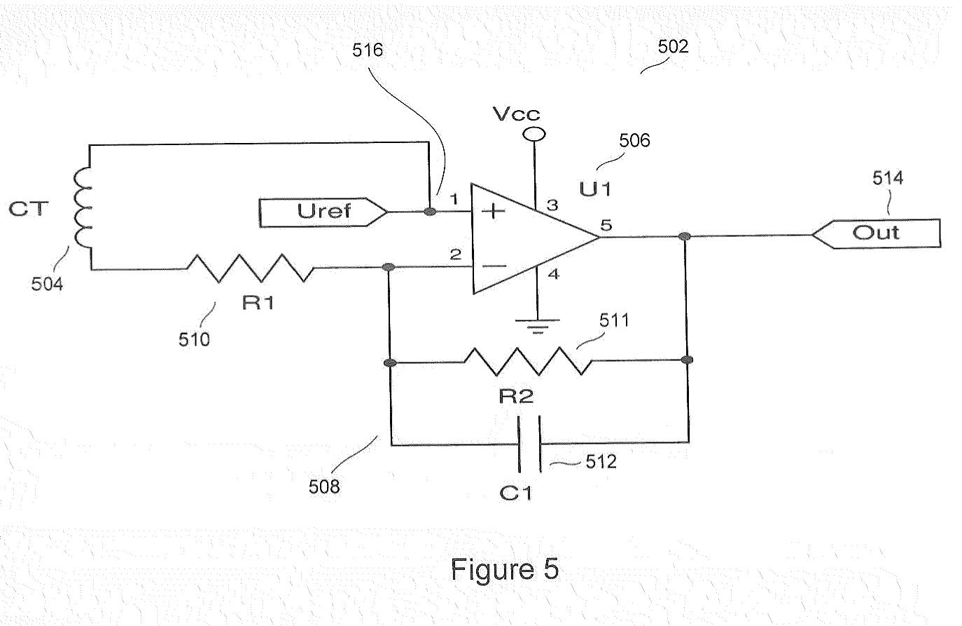

FIG. 4 shows a voltage probe used in embodiments of the present invention. The voltage probe consists of a voltage divider and a low-pass filter. The voltage divider 402 converts the input-voltage Uₚₕₐₛₑ 404 to a signal U_{adc} 406 which can be processed by an analog-to-digital converter (ADC). The low-pass filter 408 suppresses noise above the Nyquist frequency of the ADC. FIG. 5 shows a current probe used in embodiments of the present invention. The current-probe 502 consists of a current transducer (“CT”) 504 connected to a pre-amplifier 506 with an integrated low-pass filter 508. The current is sensed through an industry standard CT 504, such as a toroidal or a split-core transducer. The signal from the CT is amplified by the operational amplifier (“opamp”) 506. The low-pass filter 508 formed by the opamp, resistors 510-511, and a capacitor 512 suppresses noise above the Nyquist frequency of the ADC. The output signal Out 514 is then processed by the ADC. Note that the opamp is biased to the voltage provided at pin U_{ref} 516. The bias is chosen based on the needs of the ADC. When no bias is needed, the pin can be grounded.

### Software

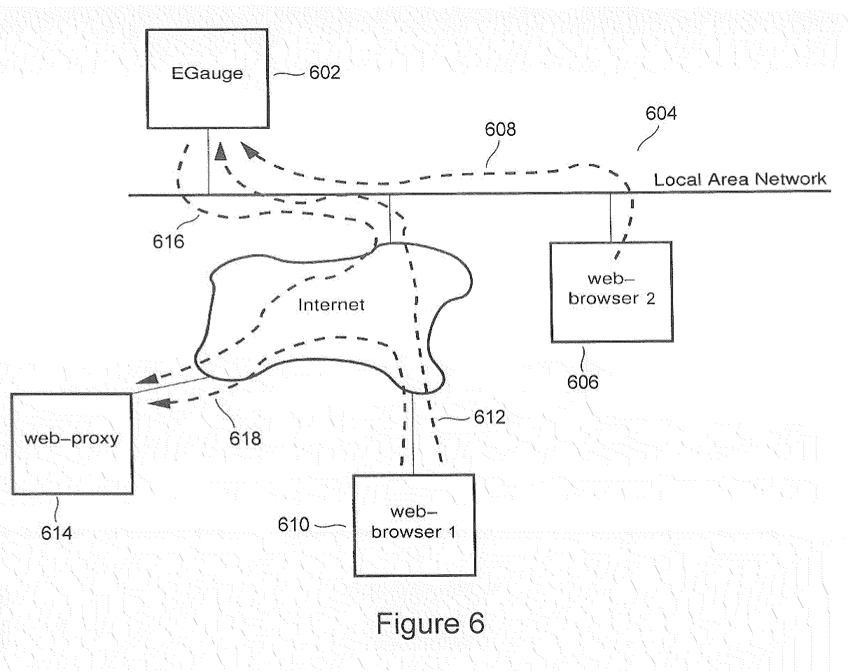

FIG. 6 is a high-level diagram showing remote access to eGauge according to one embodiment of the present invention. As shown in FIG. 6, eGauge 602 is connected to a Local Area Network (LAN) 604. Usually, the LAN will be connected to the Internet, although this connection is not required or may be sporadic, such as through a dial-up connection. Computers directly connected to the LAN may access eGauge through a web-browser 606 (or some other client software) as indicated by the dashed arrow 608. In some cases, it may also be possible to connect directly from a computer on the Internet running a web browser 610 to eGauge 602, as shown by the dashed arrow 612. However, in this case, the LAN needs to be accessible from the Internet either without any intervening firewall or, alternatively, the firewall must be configured to allow connections to the eGauge web server, such as by a forwarding rule configured in the firewall that provides that connections to port 8080 on the firewall are forwarded to port 80 on eGauge, which is typically the port number to access the web server. To provide Internet accessibility to eGauge even in cases where it is not feasible to access the LAN directly from the Internet, a web proxy 614 is provided which runs on a third-party computer. When appropriately configured, eGauge, upon power-up, establishes a connection to the configured web proxy, as shown by the dashed arrow 616. A web-browser on the Internet can then connect to the web proxy as shown by the dashed arrow 618. The web browser then sends requests to the web proxy, which forwards the requests to eGauge. Replies from eGauge are processed analogously: eGauge sends replies to the web proxy which then forwards them to the web-browser.

In one embodiment of the present invention, a primary interface to eGauge is based on Ajax-technology for the following reasons:
1. Ajax enables rich and intuitive user interfaces which make it convenient for a user to access and visualize the data collected by eGauge.
2. Ajax makes it possible to move much of the burden of data visualization from eGauge to the client. By moving this burden to the client, eGauge becomes much more scalable; that is, the CPU on eGauge cannot be as easily overloaded by client requests as would be the case were the visualization done entirely inside eGauge. In certain embodiments of the present invention, the instructions for carrying out visualization are provided, by eGauge, to the client.

### Internal Software Architecture

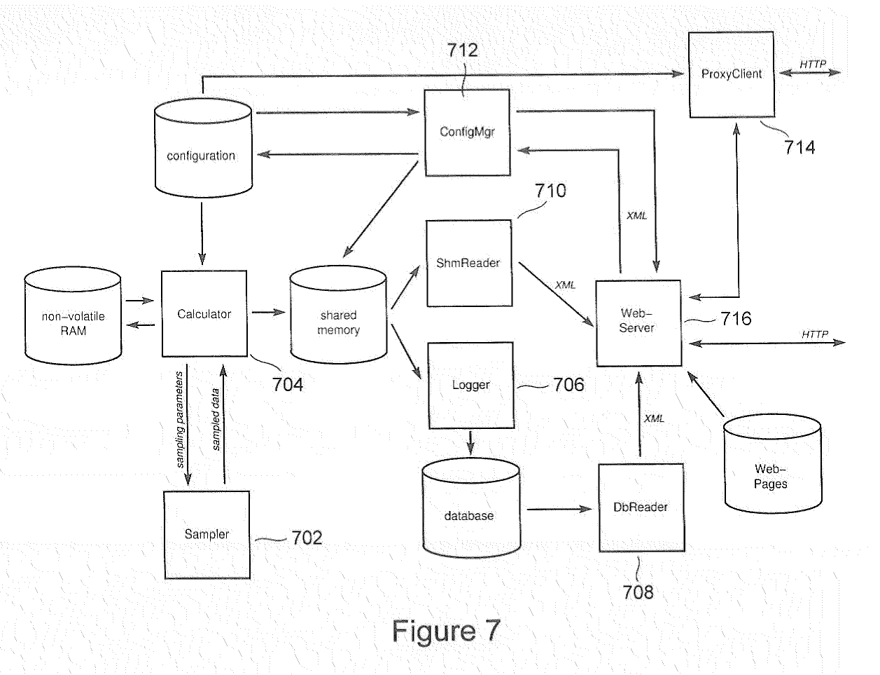

FIG. 7 shows a diagram of the software running on the eGauge hardware according to one embodiment of the present invention. Programs are shown as rectangular boxes while shared data (e.g., files or shared memory) is shown as drums. Each program is described briefly below and then in more detail in the following sections.
Sampler 702: a kernel driver which is responsible for periodically sampling the analog-to-digital converter and collecting values reported by the voltage and current probes.
Calculator 704: a program responsible for converting raw data returned by the Sampler into physical quantities (voltages and currents) and calculating true RMS power, energy, and other related quantities.
Logger 706: a program responsible for periodically reading out values produced by the Calculator and for storing them in a database.
DbReader 708: a program invoked by the web server to read some or all of the values stored in the database.
ShmReader 710: a program invoked by the web server to read some or all of the values produced by the Calculator.
ConfigMgr 712: a program invoked by the web server to read or update the eGauge configuration.
ProxyClient 714: a program responsible for maintaining a connection to the web proxy server, relaying HTTP requests to the local web server and returning replies from the web server to the web proxy server.
Web Server 716: a program that is an HTTP-compliant web server.

### Sampler (Kernel Driver)

The Sampler is a kernel-level module which is responsible for periodically sampling the analog-to-digital converter to read the values present at the input channels. Depending on the hardware configuration, each input channel is connected either to a voltage probe or a current probe or not connected at all. In certain embodiments, the input channels may be connected to a probe through a hardware jumper or through a software-controlled switch. The Sampler is implemented as a kernel module to ensure relatively precise and consistent timing of input-channel sampling. Consistent timing directly affects the accuracy with which the overall system performs. The Sampler is configured from user space through a control channel and returns data through the same channel. In certain embodiments, the Sampler is realized as a Linux kernel module and the control channel is accessed by opening the special file /proc/driver/max19x. Once opened, the Sampler, in certain embodiments, is configured by sending one or more or the following commands on the control channel:
freq=f: This command selects the sampling frequency. The desired frequency f is specified in Hertz (samples/second).
chn=c: This command selects the configuration of channel n. The configuration string c depends on the capabilities of the ADC. In one instance, using the MAX199 ADC, the configuration string consists of a comma-separated list of “unipolar” or “bipolar” to select the polarity of the channel, or “full” or “half” to select the range. The number of channels is hardware dependent. In certain embodiments, there are eight channels so that n may take on any value from 0 through 7.
order=o: This command selects the order in which the channels are read during each sampling interval. Order o is a comma-separated list of channel numbers. For example, the command “order=0, 1, 0” requests that during each sampling interval channel 0 is read first, followed by channel 1, and then channel 0 is read again.
start: This command instructs the Sampler to start sampling data according to the most recently established configuration.
stop: This command instructs the Sampler to stop sampling data.

The sampled data can be read from the control channel in the following line-oriented format:
n:v t

Here, n is the index within the sampling order that was established with the “order” command, v is the value of the sample represented as a hexadecimal string, and t is a time stamp indicating when the sample was acquired, represented as a hexadecimal string. The resolution and maximum value of the time stamp is hardware dependent. In one instance, the time stamp is an unsigned 32-bit value which is incremented once every 1.0173 μs (which corresponds to a clock frequency of 983,040 Hertz). As a special case, when sampling data is lost because data is read from the control channel too slowly, the control channel returns a line in the form:
#N
   where N is the number of samples that were lost. Note that there are numerous formats for commands sent on, and the data returned from, the control channel that may be used in various embodiments of the present invention. For example, the commands and data can be encoded in a binary format or data can be returned via shared memory. Some of the key points here are that the Sampler can be configured from user space, that it samples the channels in a configurable order and with relatively precise and consistent timing, and that the data is returned to user level in some fashion.

In one instance, the Sampler is realized by configuring Timer2 of an EP9302 microcontroller to generate periodic interrupts using a MAX199 chip as the ADC and configuring Timer4 of the EP9302 microcontroller as the time stamp counter. Timer2 is set up to generate periodic interrupts with a frequency equal to the desired sampling frequency. Timer4 is set up to count at a fixed frequency (e.g., 983,040 Hertz). MAX199 is configured based on the “chn” commands issued on the control channel.

To buffer sampled data, a ring buffer with a fixed number of entries, such as 64, is used. When the ring buffer fills up, subsequent samples are dropped until there is again free space. Each time an interrupt occurs, the Sampler performs the following actions:
1. Acknowledge the interrupt.
2. When the ring buffer is full, increment the buffer-overflow counter and do nothing else.
3. Perform the following steps for each channel n in the order in which the channel appears in the list established by the “order” command:
   (a) Read the value present at channel n of the ADC.
   (b) Read the current time stamp from Timer4.
   (c) Store the channel value and time stamp in the ring buffer.
4. Wake up any processes that may be reading the control channel. Each time a command is written to the control channel, the Sampler performs the following actions:
1. When data is being sampled, stop the sampling.
2. Update the configuration according to the command that was written to the control channel.
3. If the command is “start” and the sampling order already has been established with the “order” command, start sampling. That is, configure Timer2 to generate a periodic interrupt with a frequency equal to the desired sampling frequency.
   Each time a process attempts to read data from the control channel, the Sampler performs the following actions:
1. when the ring buffer is empty, wait until data is available (that is, until a sampling interrupt has occurred).
2. Write the sampled data to the control channel in the format described earlier. Repeat this until either the ring buffer is empty or there is no more space to write more data.

### Calculator

The Calculator reads raw values returned from the Sampler and converts them to mean (real) power and energy figures. This is accomplished in multiple steps. Given a time-dependent voltage u(t) and a time-dependent current i(t), instantaneous power p(t) can be calculated as p(t)=u(t)i(t). Assume that u(t) and i(t) are periodic. In North America, power as distributed by utilities is periodic with a frequency of 60 Hz, whereas in other parts of the world it is periodic with a frequency of 50 Hz. The eGauge hardware samples (several) u(t) and i(t) at a configurable frequency fₛ. To avoid aliasing problems, the frequency fₛ is selected to be at least four times as high as the cut-off frequency of the low-pass filters in the voltage and current probes. At the same time it is desirable to select fₛ as low as possible to minimize the computational load on the CPU. eGauge collects one or several periods' worth of sampled values of u(t) and i(t) and then calculates the mean power over that time period. Specifically, assume eGauge collects N voltage samples uₙ and iₙ for n in 0, . . . , Ñ−1, respectively. The sampled power values are then given as pₙ=uₙiₙ. The discrete Fourier transform (“DFT”) coefficients of the samples of a periodic signal is given by:

$${P}_{k} = \frac{1}{N} {\sum }_{n = 0}^{N - 1} {p}_{n } {e}^{- \frac{2 π j}{N} kn} where k ∈ 0 … N - 1 ; and j = \sqrt{- 1}$$

P₀ is the DC component, or mean value, of the signal. When the above formula is evaluated for k=0, P₀ is equal to 1/NΣₙ₌₀^{N-1}pₙ because e⁰=1. In other words, the mean value of the underlying signal is simply the mean of the sampled values. Note, however, that this is true only when conditions of the discrete Fourier transform are met. Specifically, the sampling frequency must be at least twice as high as the highest-frequency component in p(t), 4f₁, where f₁ is the cut-off frequency of the low-pass filters in the current and voltage probes. Furthermore, the DFT also assumes that the time from one sample to the next is exactly the same. Due to the non-deterministic nature of modern CPUs and computer systems, this may not always be true. When there is too much variation in the time between neighboring sampling points, accuracy can be improved by weighing each sample with the time to the next sampling point and then dividing the sum by the total duration. For example, if samples uₙ and iₙ are obtained at times tₙ, then the mean power is calculated as 1/(t_{N-1}−t₀)Σₙ₌₀ⁿ⁻²(uₙ·iₙ)(tₙ₊₁−tₙ). With the mean power pᵢ calculated for an interval i of duration dt, the energy E consumed (or produced) during that time is the product of the two quantities:

Eᵢ=pᵢ·dt

The total energy consumed or produced over time is then obtained by continually adding the E values for each interval:

Eₜₒₜ=Σᵢ₌₀⁻Eᵢ.

The root-mean-square (RMS) values of the voltage and current are calculated, respectively, as:

$${U}_{rms} = \sqrt{\frac{1}{N} {Σ}_{n = 0}^{N - 1} {u}_{n}^{2}} {I}_{rms} = \sqrt{\frac{1}{N} {Σ}_{n = 0}^{N - 1} {i}_{n}^{2}}$$

The power factor pf is defined as the quotient of real power P (measured in Watts) and apparent power S (measured in Volt-Amperes). Apparent power can be calculated as the product of the RMS voltage and current and the real power is equal to the mean power as defined in the previous section. In other words:

$$pf = \frac{P}{S} = \frac{P}{{U}_{rms} \cdot {I}_{rms}}$$

The frequency of the voltage signal can be calculated by measuring the time between two successive rising zero-crossings, where a rising zero-crossing is said to occur when the voltage changes from a negative to a non-negative value.

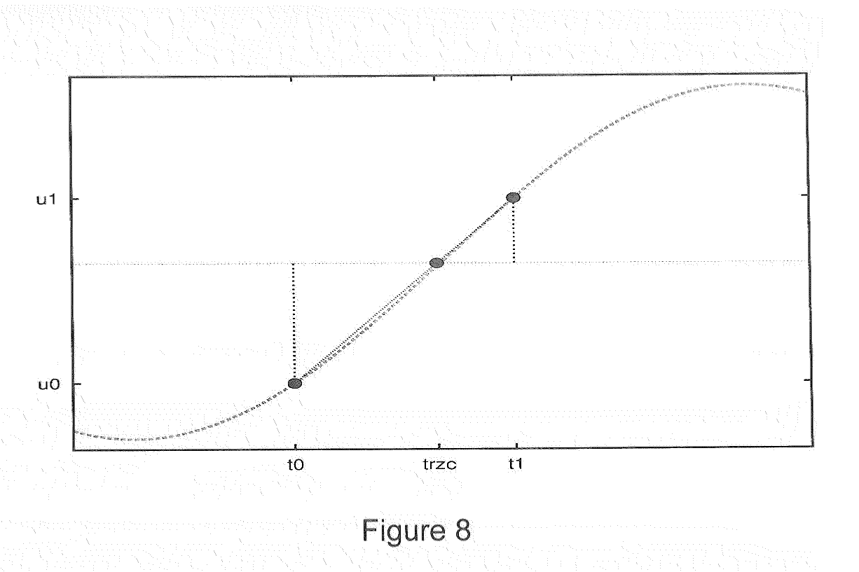

To improve accuracy, eGauge measures, in certain embodiments, the time across N rising zero-crossings, where N is equal to 60. Accuracy is further improved by using linear interpolation to better estimate when the zero-crossing occurred. FIG. 8 illustrates linear interpolation of measurement across multiple rising zero-crossings. Specifically, suppose that at time t₀ the voltage has a negative value u₀ and at time t₁ the voltage has a positive value u₁, as illustrated in FIG. 8. The rising zero-crossing is then estimated to have occurred at time:

$${t}_{rzc} = {t}_{1} - {u}_{1} \frac{{t}_{1} - {t}_{0}}{{u}_{1} - {u}_{0}}$$

Given the time t_{rzc}_{₁} of the first rising zero-crossing and the time t_{zrc}_{_{N}} of the N^{th} rising zero-crossing, the frequency f is then calculated as:

$$f = \frac{N - 1}{{t}_{{rzc}_{N}} - {t}_{{rzc}_{0}}}$$

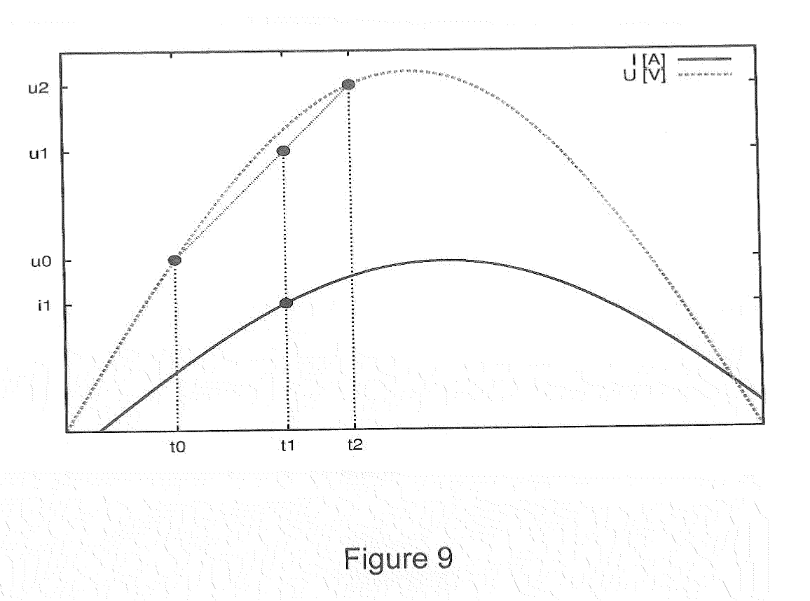

It has been assumed that the voltage uₙ and current iₙ needed to calculate instantaneous power pₙ can be measured simultaneously. When there is only a single ADC whose input is multiplexed among the different input channels, this is clearly not feasible. Each analog-to-digital conversion will require a certain amount of time, preventing acquisition of two samples simultaneously. To circumvent this problem, eGauge uses one or more voltage samples to interpolate (or extrapolate) the voltage to the point when the current sample was taken. With step extrapolation, the voltage at time t₁ is assumed to be the same as the voltage of the previous sample. That is, uₜ_{₁}=uₜ_{₀}. With linear interpolation, the voltage at time t₁ is a linear interpolation of an earlier voltage sample u₀ taken at time t₀ and a later voltage sample u₂ taken at time t₂. FIG. 9 illustrates linear interpolation to interpolate the voltage at the point when a current sample was taken. As shown in FIG. 9, a voltage sample uₜ₀ is taken at time t₀ and another u₁₂ at time t₂ and the current sample iₜ_{₁} is taken at time t₁. The voltage at time t₁ is estimated as:

uₜ₁=uₜ₀+(t₁−t₀)(uₜ₂−uₜ₀)/(t₂−t₀)

With quadratic interpolation, three voltage samples uₜ₀, uₜ₁, and uₜ₂ are taken at times t₀, t₁, and t₂, respectively. A quadratic curve is then fitted through these points by calculating the parameters a, b, and c as:

$$a = \frac{( {u}_{t 1} - {u}_{t 0} ) ( {t}_{0} - {t}_{2} ) + ( {u}_{t 2} - {u}_{t 0} ) ( {t}_{1} - {t}_{0} )}{( {t}_{0} - {t}_{2} ) ( {t}_{1}^{2} - {t}_{0}^{2} ) + ( {t}_{1} - {t}_{0} ) ( {t}_{2}^{2} - {t}_{0}^{2} )}$$

$$b = \frac{( {u}_{t 1} - {u}_{t 0} ) - a ( {t}_{1}^{2} - {t}_{0}^{2} )}{{t}_{1} - {t}_{0}}$$

$$c = {u}_{t 0} - {at}_{0}^{2} - {bt}_{0} .$$

With the parameters calculated in this fashion, the voltage at the time tᵢ when the current sample was taken is then estimated as uₜᵢ=atᵢ²+btᵢ+c.

While eGauge may use any of the above-mentioned interpolation schemes, it presently uses linear interpolation since that offers good accuracy at a small computational cost.

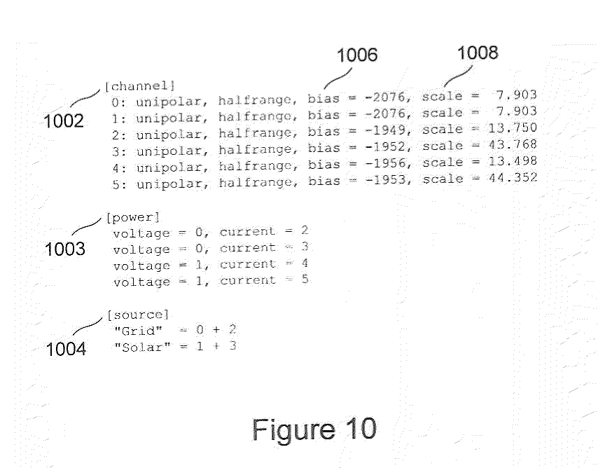

In certain embodiments, eGauge supports multiple voltage and current channels and a configuration file typically stored in /etc/egauge.conf defines which ADC input channels are voltage vs. current channels and how these channels should be combined to calculate power figures. FIG. 10 illustrates an example of the contents and format of the configuration file. As the example shows, the configuration file contains multiple sections, the names of which are enclosed in angle brackets 1002-1004. In the example we see sections “channel,” “power,” and “source.” The “channel” section defines how the ADC's channels should be configured via the Sampler and how the values returned from the Sampler should be converted to physical quantities. Specifically, the “bias” keyword 1006 defines a value that should be added to the sampled value and the “scale” keyword 1008 defines a value that the sampled value should be divided by, after applying the bias. For example, if a sampled value of 3012 were returned for channel 0, the actual physical value would be (3012-2076)/7.903=118.4. The “power” section defines the number of power (and also energy) values that are calculated and how they can be calculated from the input channels. In the example there are four powers: the first is calculated from the voltage on channel 0 and the current on channel 2; the second power is calculated from the voltage on channel 0 and the current on channel 3, and so on. The “source” section defines how the power (and energy) values are assigned to power sources. In the example there are two power sources: “grid” and “solar.” The grid source is defined to be the sum of the first and third power defined in the “power” section. The “solar” source is defined to be the sum of the second and fourth power defined in the “power” section. In other words, the configuration file contains information needed by the Calculator to determine how to calculate the power (and therefore energy) values for each power source.

The Calculator needs to determine a sampling schedule or, in other words, an order in which the input channels should be sampled during each sampling interval. The sampling schedule depends on the configuration file, the number of ADCs present in the hardware, and the voltage interpolation method being used. Linear interpolation is assumed in the described embodiment, but other interpolation methods may be used in alternative embodiments. With linear interpolation, two voltage samples are needed for each current sample. Thus, for each unique voltage/current combination mentioned in the “power” section, three samples need to be acquired so that with N, entries in that section, a total of 3N, samples need to be acquired per sampling interval. Since it takes a finite time to acquire a sample, it is worthwhile to optimize the schedule so that the number of samples is minimized. For this reason, the Calculator has a Sampling Schedule Optimizer which orders the entries in the “power” section by the voltage-channel number. Entries with the same voltage-channel number are scheduled next to each other. By doing so, the second voltage sample can also serve as the first voltage sample of the next entry, when they share the same voltage channel. With this optimization, the Calculator may need to acquire only as few as 2N_{P}+1 samples, when there is a single voltage channel. More generally, when there are N_{V} voltage channels and N_{P}/N_{V} entries in the “power” section per voltage channel, a total of N_{V} (2N_{P}/N_{V}+1)=2N_{P}+N_{V} samples per interval need to be acquired. For the “power” section shown in FIG. 10, the Sampling Schedule Optimizer may compute the following sampling schedule:
0 2 0 3 0 1 4 1 5 1
   That is, the sampling schedule has 10 entries. Since N_{P}=4 and N_{V}=2, this is consistent with 2N_{P}+N_{V}=2·4+2=10.

A second type of optimization becomes possible when there is more than one ADC in the system. In such a case it is advantageous to assign the input channels so that the current channel and the corresponding voltage channel are on separate ADCs. Since there are usually relatively few voltage channels, it can even be worthwhile to duplicate each voltage channel on each ADC since that will ensure that, for any voltage/current pair, a channel pair can be found that is on a separate ADC. The advantage of using separate ADCs comes from the fact that they can operate in parallel. Generally, acquiring a single sample on an ADC can be broken up into three phases: setup, acquisition, and result transfer. Each phase is approximated as taking a fixed time T_{S}, T_{A}, and T_{R}, respectively. With a single ADC, acquiring two samples takes time equal to 2(T_{S}+T_{A}+T_{R}). In contrast, acquiring two samples on two separate ADCs takes only T_{S}+T_{A}+2T_{R}, assuming T_{S}≦T_{A}. Since T_{A} is usually much longer than T_{S} or T_{R}, acquiring the samples on two separate ADCs almost doubles the speed with which the samples can be acquired. Moreover, when sample times are sufficiently small and constant for the ADCs in use, it is possible to use step interpolation rather than linear (or even quadratic) interpolation, thus reducing the number of samples needed to the minimum of 2N_{P}. In the example of FIG. 10, assuming that the voltage channels are on ADC0 and the current channels are on ADC1, a possible sampling schedule is:
ADC0.0 ADC1.2 ADC0.0 ADC1.3 ADC0.1 ADC1.4 ADC0.1 ADC1.5
   Note that this schedule is slightly shorter, with eight entries, as compared to the previous schedule with ten entries. But, in addition to being shorter, it also can be executed faster, needing time only equal to 4 (T_{S}+T_{A}+2T_{P}), compared to 10(T_{S}+T_{A}+T_{R}) for the original schedule with a single ADC.

Higher speeds may be achieved by using a separate ADC for each current channel that needs to be acquired along with a given voltage channel. Again, assuming that T_{S} is sufficiently small, only N_{V}+(N_{P}/N_{V}) samples need to be acquired, and the time to do so is equal to only N_{V} (T_{S}+T_{A}+(N_{P} N_{V}+1)T_{R}). In the example of FIG. 10, assuming that the voltage channels are on ADC0, current channels 2 and 4 are on ADC1, and current channels 3 and 5 are on ADC2, a possible sampling schedule is:
ADC0.0 ADC1.2 ADC2.3 ADC0.1 ADC1.4 ADC2.5
   Since N_{V}=2 and N_{P}=4, the total time required to execute this schedule is only 2(T_{S}+T_{A}+3T_{R}).

In the most extreme case, each channel may have its own ADC, yielding a sampling time of (T_{S}+T_{A}±N_{P}T_{R}). The downside of using more ADCs is increased hardware cost, so speed and cost need to be balanced. Being designed as a low-cost device, in certain embodiments, eGauge utilizes the minimum number of ADCs that provide enough speed to accommodate the required number of channels.

With the above-provided background, the operation of the Calculator program can be described by the following steps:
1. Attach to the shared-memory segment (or create a new shared-memory segment).
2. Open a control channel to the Sampler.
3. Open a control channel to the non-volatile RAM.
4. Read the configuration file.
5. Determine and optimize the sampling schedule.
6. Configure the Sampler based on the “channel” section of the configuration file.
7. Tell the Sampler to start acquiring samples.
8. For each entry n in the “power” section of the configuration value, read the most recent energy value from the non-volatile RAM.
9. Repeat the following steps:
   (a) Read one sampling interval's worth of samples.
   (b) Convert the samples to voltages and currents using the “bias” and “scale” values in the configuration file's “channel” section.
   (c) Use the samples to update the frequency.
   (d) Use the samples to update the sum of squares needed to calculate the RMS voltages and RMS currents.
   (e) Use the samples to interpolate the voltages to a point in time when the corresponding current samples were acquired and use the results with the corresponding current samples to approximate the mean powers for the most recent sampling interval. Then add those power values to a running sum of power values.
   (f) After accumulating data over K sampling intervals, perform the following steps:
      i. Calculate the RMS voltages and RMS currents by dividing the sums of squares by K and taking the square root. Clear the sums to zero.
      ii. Calculate the mean (real) powers by dividing the running sums of power values by K. Multiply the mean powers by the elapsed time and add the results to the running sums of energy values. Clear the running sums to zero.
      iii. Optionally calculate the power factors based on the RMS voltages, RMS currents, and mean powers.
      iv. Update the shared memory with the values calculated in the previous steps.
      v. When T_{NVRAM} seconds have expired since the last update, store the currents' energy values in the non-volatile RAM.

In a typical eGauge configuration, the Calculator processes thousands, if not ten of thousands, of samples every second. Were the calculator unable to keep up with that load, data would be lost, and the calculated values would quickly become inaccurate. The Calculator therefore is given priority to access the CPU whenever the Sampler doesn't need to. This is generally achieved by marking the Calculator as a “soft real-time” process. For example, on Linux, this can be achieved by selecting the “FIFO” scheduler for the Calculator. eGauge is designed so that the Calculator is the only process using this scheduler. Every other process uses the standard UNIX scheduler, which has lower priority. With this setup, the Calculator is the highest-priority user-level process and gets to run whenever it needs to, unless the kernel preempts it for some kernel work.

Related to the issue of timeliness is efficiency. Note that most of the calculations are most easily performed in some floating-point format, such as IEEE-754. However, to keep hardware costs and power requirements low, eGauge may run on a CPU without a hardware floating-point unit. On such hardware, eGauge can be configured to do calculations in a fixed-point format that is 32 bits wide and uses four of those bits to represent fractional values. The eGauge software is constructed to ensure that this format can provide sufficient accuracy while avoiding overflows.

### Logger

The Logger is responsible for periodically reading the energy values and other values from the shared memory and storing them in a database. The design of the database format addresses several considerations:

1. In general, there is an upper size beyond which the database does not grow.

2. The database needs to store data compactly.

3. Recent data needs to be available with relatively fine granularity.

4. Historic data needs to remain available for as long as feasible.

The first point relates to an eGauge operating properly and autonomously for relatively lengthy periods time. The second point addresses minimizing wasted space. In other words, a relatively small amount of non-volatile storage is able to store adequate amounts of data when waste in storage is minimized and, therefore, hardware costs are kept low. The third point provides for storage of sufficient data to enable the observation and analysis of recent events with good detail and to give near-immediate or near-real-time feedback to an observer of eGauge. The fourth point provides for data being available long enough to enable the calculation of useful statistics, such as monthly power-use/production summaries, averaged over several years.

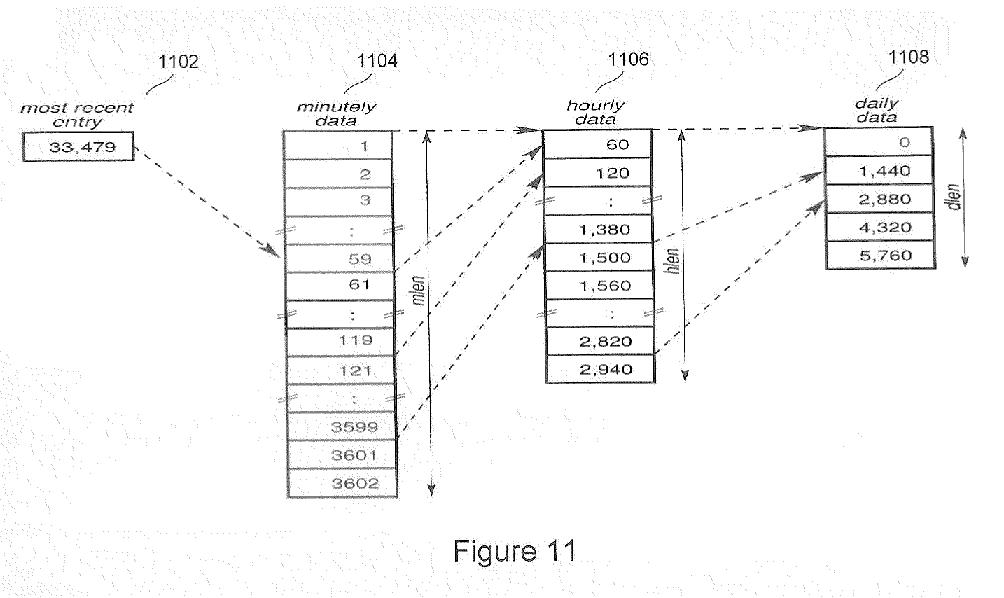

While the above-listed points may seem to potentially conflict with one another, they can be accommodated without conflict with proper choice of database design. FIG. 11 illustrates a hierarchical and cyclical database design used in certain embodiments of the present invention. As shown in FIG. 11, there are multiple hierarchy levels 1104, 1106, and 1108 in the database, recording data at a coarser granularity, in left-to-right order. In the exemplary database design shown in FIG. 11, three levels are shown, one 1104 recording data at minute-interval granularity, one 1106 at hour-interval granularity, and one 1108 at day-interval granularity. Within each level there are multiple slots to record captured data values. Each level may have a different number of slots. In the example, the first (minute) level has mien slots, the second (hour) level has Men slots, and the last (day) level has dlen slots. The slots are treated as if arranged in a circle. Specifically, the logger records data slot by slot. After the last slot has been written, the logger wraps around and the next record is written to the first slot, overwriting whatever was stored there before. The cyclical organization of the database ensures that the storage requirements remain bounded.

FIG. 11 also illustrates that a given record is written at one, and only one, level. This property avoids duplication of data and hence results in a more compact database. To illustrate this, consider that the minute level stores the records for minutes 1-59 and 61-119, but not for minute 60. This is because 60 minutes is a full hour, and therefore that record is stored at the hour level. Similarly, the hour level records minutes 60, 120, . . . , 1380 but not minute 1440, since that is not just a full hour but also a full 24 hours, and hence that record is stored at the day level.

To further save space, the database only records the actual data (e.g., energy values) in each slot—there is no index information. Instead, the database has a separate file 1102 recording the most recent entry, shown in the figure on the left. This file contains the absolute time stamp for the slot that was written most recently. Usually, but not necessarily, the time stamp is measured as “seconds since midnight, Jan. 1, 1970.” Because in our example the finest level of granularity is minutes, the time stamp is always a multiple of 60 (seconds). Note that the time stamp does not necessarily identify a slot in the minute level. If the time stamp is an integer multiple of 3600 (one hour), then it identifies a slot in the hour level, and if it is an integer multiple of 86400 (one day), then it identifies a slot in the day level. The index of the slot within the level is then obtained by dividing the time stamp by the granularity of the level (in seconds) and adjusting for any records stored at a higher level.

More formally, given a time stamp t (in seconds), the time stamp is converted to level l and slot index i as follows: starting at the highest level, divide t by gₗ, the level's granularity (also in seconds). If the remainder of the division is zero, the currently considered level is the level sought. Otherwise, the next lower level is considered and the division repeated. Once the sought level l is found, the slot index can be calculated based on the number of slots n, in level l and the maximum level number lₘₐₓ as follows:

$$j = t / {g}_{l} {mod n}_{l .}$$

$$i = j - ⌊ \frac{{j}_{{g}_{l}}}{{g}_{l + 1}} ⌋ - 1 , if l < {l}_{max } , \\ i = j , if l = {l}_{max}$$

Intuitively, j is the slot number within a level when the database does not have any higher levels. The term L └j_{gl}/gₗ₊₁┘ gives the number of records that are stored in a higher level, minus one.

The above formulas allow for mapping any time stamp t to a level l and index i and hence allows for retrieving any records that are still stored. One can determine whether a record is still stored at a given level l by checking whether it is at most nₗ slots away from the slot corresponding to the most recently written slot. When a given record can no longer be found at level l, it may be desirable to approximate the data corresponding to the record based on the nearest values that can be found at a higher level.

### DbReader

The DbReader program is invoked by the web server to read out the historic data stored in the database written by the logger. The web server typically invokes the DbReader via the Common-Gateway-Interface (“CGI”), requesting data for a time range tₛ . . . tₑ, spaced out by a time interval of at least g seconds.

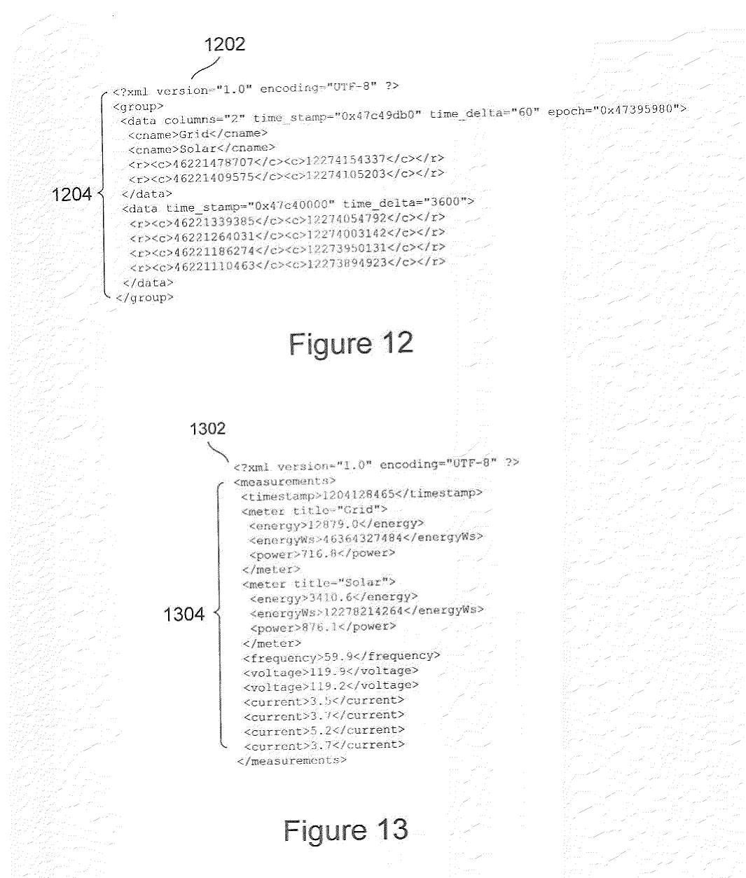

The method by which a time stamp t can be mapped to the position in the database at which the corresponding values are stored is discussed above. Given a request (tₛ, tₑ, g) from a web server, the DbReader queries the database for records with time stamps in the range tₛ . . . tₑ, rounded to granularity g. If a record does not exist for the exact time stamp t, then DbReader may substitute the nearest existing record for the desired record according to one embodiment of the present invention. FIG. 12 illustrates an .XML format in which DbReader returns data to the web server. As shown in FIG. 12, the format starts with an XML-header 1202, indicating its version (1.0) and character-set encoding (UTF-8). The actual data is returned within a group element 1204. Within a group there may be one or more data elements.

The first data element defines a column attribute specifying the number of columns in which the following data is included. Data elements carry the time_stamp and time_delta attributes. The former defines the time stamp of the first row of data that follows, and the latter defines the time interval between subsequent rows. Data is returned in order of decreasing time stamps (that is, the most recent values are returned first). The element may carry an epoch attribute which, if present, defines the time stamp at which the Logger began recording data.

Within the first data element there are as many cname elements as there are columns. Each cname element names a column in the order in which it appears. In the example shown in FIG. 12, the first column is named “grid” and the second is named “solar”. The DbReader generates these names based on the contents of the “source” section in the configuration file. Data elements contain at least one r element, which defines a data row. Within this element there must be as many c elements as there are columns, as defined by the columns attribute of the first data element. The actual data values are encoded as decimal numbers. In the example, the values displayed are energy values in Watt Seconds. For example, 46221478707 would correspond 46,221,478,707 Ws or 12,839 kWh. When the returned data has time stamps that differ from each other by a constant amount (the time-delta), a single data element can be used. Otherwise, a new data element is used whenever the time-delta changes relative to the previously output data. Note that the data format has been optimized for compactness: as much data as possible is packed into as few characters as possible, subject to the constraints imposed by XML. This minimizes networking resource overhead, because fewer bytes of data are transmitted across the network. Further savings can be achieved by compressing the datastream with a compression-algorithm such as “gzip” or “deflate,” as provided for by HTTP/1.1 in the form of the “Content-Encoding” header.

### ShmReader

The ShmReader program is invoked by the Web server via CGI. The web server invokes ShmReader to fetch current data from the shared memory. FIG. 13 illustrates the XML format in which ShmReader returns data to the web server according to one embodiment of the present invention. As the example in FIG. 13 shows, the format starts with an XML-header 1302 indicating version and encoding, just like the output format of the DbReader. The actual data is enclosed in a measurements element 1304. Within this element, a number of different elements may be included:
time stamp: a decimal number which specifies the time at which the other data was acquired, measured in seconds since midnight, Jan. 1, 1970. When the time stamp has a granularity finer than seconds, the integer part of the time stamp may be followed by a decimal point and a fractional part.
meter: measurements related to a particular source (as defined in the configuration file), and a title attribute specifying the source name, along with the following optional sub-elements:
   energyWs: the total (net) energy measured for this source, expressed in Watt seconds.
   energy: the total (net) energy measured for this source, expressed in kilowatt hours.
   power: the mean power measured for this source for most recent measurement interval.
frequency: the frequency of the first voltage channel as measured in the most recent interval, in Hertz (cycles/second).
voltage: the RMS voltage measured by a voltage probe, in channel order.
current: the RMS current measured by a current probe, in channel order.

Note that the above list of elements that may appear within a measurements element is not exhaustive. The format is extensible, and other values may be added over time. For example, the physical location of eGauge could be communicated with a loc element, the contents of which specifies the longitude and latitude of the eGauge. Similarly, the time zone effective at the eGauge location could be communicated with a tz element.

### Web Server

In certain embodiments, eGauge uses the Apache web server for web-serving needs. The web server is configured to listen both to ports 80 and 8080. The latter is enabled to make it easier to enable port-forwarding in a firewall. Specifically, it facilitates configuring a firewall to forward any packets to port 8080 to eGauge. This can be easier than configuring the firewall to remap packets from port 8080 to port 80, for example. The web server is configured to require user authentication when performing any security-sensitive operations, such as configuring eGauge or upgrading its software.

### Web Software

As described earlier, certain embodiments of eGauge are organized around Asynchronous JavaScript and XML (“Ajax”). In addition, for rendering graphs, certain embodiments of eGauge use Scalable Vector Graphics (“SVG”), Vector Markup Language (“VML”), and Cascading Style Sheets (“CSS”).

### Access Via Low-Level XML Interfaces

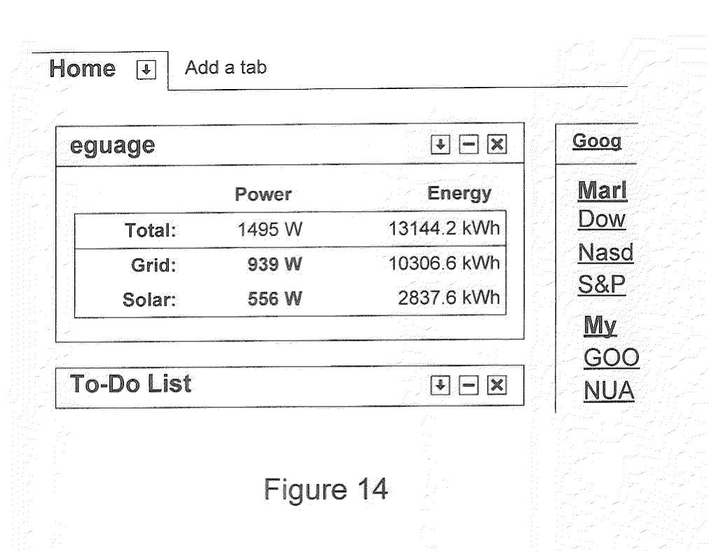

At the lowest level, eGauge provides access to the raw data in XML-format via CGI-programs such as ShmReader (current data) and DbReader (historic data). This low-level interface enables a large amount of flexibility and makes it possible to display the collected data in various ways, further process the data to calculate and to then display, derived values (such as long-term statistics), and carry out other useful operations and tasks. FIG. 14 shows a Google Gadget that can be added to a customized iGoogle home page according to one embodiment of the present invention. Once added, the gadget updates power and energy figures from the configured eGauge every five seconds. The Google Gadget operates as follows:
1. Every five seconds the Google Gadget fetches the current XML data from an eGauge through a configurable URL. The URL typically is of the following form:
   http://www.egproxy.com:81/c/egaugeN/cgi-bin/egauge?
2. By fetching the above URL, the ShmReader is invoked and the targeted eGauge's current data is returned as XML-formatted data.
3. The Google Gadget parses the XML data, reads the basic energy data, and calculates the desired derived values, such as total power consumed, from the basic data.
4. The calculated data is formatted as an HTML table and then rendered in the display area reserved for the eGauge Google Gadget.
   While the eGauge Google Gadget is interesting and useful in its own right, the Google Gadget additionally illustrates the versatility of eGauge exposing data via low-level XML interfaces. The same approach is used, for example, to render eGauge data on mobile phones, PDAs, and other devices. The low-level XML interfaces can also be used, for example, for data aggregation. With many eGauge devices deployed, it becomes possible to collect useful statistics and reveal global patterns that are difficult or impossible to discern at the individual device level. For example, aggregation makes it possible to calculate average observed solar production hours on a regional basis. Similarly, aggregate consumption data would reveal patterns that could be very helpful to electric utilities for rate planning, evaluating the effectiveness of energy-savings campaigns, and similar purposes.

### Built-In Data Visualization

While the low-level XML interfaces provide a large amount of versatility, eGauge also includes convenient and powerful built-in data visualization capabilities. An example of this visualization was shown in FIG. 2. In one embodiment of the present invention, a single graph is used to display four distinct quantities:
Total power consumed.
Amount of power generated locally.
Amount of energy drawn from utility grid.
Amount of energy supplied into utility grid.
   This graph is obtained as follows:
1. Given a number of power sources S, classify each source as either: (a) utility-provided; or (b) locally generated. This can be done, e.g., based on the names of the sources as they appear in the configuration file: sources with names starting with “grid” are treated as utility provided, sources with names starting with “solar” are treated as locally generated.
2. Given a series of energy values E_{S1}, . . . , E_{SN} for each source S, which were measured at times t₁ . . . , t_{N}, respectively, calculate the average power of each source for each time-interval as:

$${P}_{Si} = \frac{{E}_{Si + 1} - {E}_{Si}}{{t}_{i + 1} - {t}_{i}}$$

3. For each i:
   (a) Calculate the utility-supplied total power P_{Ui}, by adding up the P_{Si}, of sources S classified as utility provided.
   (b) Calculate the locally generated total power P_{Li}, by adding up the P_{Si}, of sources S classified as locally generated.
   (c) Calculate the total consumed power for each time interval as:

P_{Ti}=P_{Ui}+max(P_{Li},0).
The total power consumed at a site is equal to the sum of the utility-provided power and the locally generated power. Note that P_{Ui} and P_{Li} may be negative at times: the former is negative when more power is being produced locally than the site consumes (i.e., power is fed back into the utility grid), and the latter is negative when no power is being produced locally but instead the local generation facility uses some power. For example, this commonly happens with photo-voltaic solar systems when the sun does not shine, because even though no power can be generated, the inverters in the system still consume a small amount of power. However, when P_{Li} is negative, it must not be added into P_{Ti} because the power the local generation facility consumes is already measured as part of the utility-provided power P_{Ui}. This is the reason for the max-operator in the above equation.
(d) Draw a first color-coded horizontal line from the point corresponding to time tᵢ₋₁ to the point corresponding to time tᵢ at a height corresponding to P_{Ti}. This is a segment of the curve for the total power consumed at the site.
(e) Draw a second color-coded horizontal line from the point corresponding to time tᵢ₋₁ to the point corresponding to time tᵢ at a height corresponding to P_{Li}. This is a segment of the curve for the locally generated power.
(f) If P_{Ti}>P_{Li}, shade the area between the two previously drawn line segments using the first color; otherwise, shade the area in the second color.

With few energy values, the above procedure will yield a stair-stepped curve. As more energy values are used to render the graph, the curves get smoother. In the limit, where each value is represented by a line that is at most one pixel wide, the curves will be completely smooth, as illustrated in the example in FIG. 2. Whether or not the rendered curves are smooth or stair-stepped is a function of the time range that the user wants to display and the number of energy values that are available in that time range. The stair-stepping effect that occurs when there are few values available is useful because it conveys to the user the period of time over which the power was averaged.

The graph can be generalized to the case where the components contributing to the utility-supplied and solar-supplied power need to be displayed separately. This can be achieved, for example, by rendering a thinner line at the height of each contributing component. For example, with a photo-voltaic solar system with three inverters, it may be desirable to display separately the power produced by each inverter. The first thin line is rendered at the height corresponding to the power produced by the first inverter, the second thin line is rendered at the height corresponding to the sum of the power produced by the first two inverters, and the third thick green line is rendered at the height corresponding to the sum of the power produced by all three inverters. Instead of, or in addition to, varying the thickness of lines, it is also possible to use different line patterns to distinguish the components (e.g., dashed vs. dotted).

The graph displaying power usage and generation history is continually updated as new data becomes available (e.g., once per minute). Also, different “zoom” levels can be selected to view different periods of times and the historic data can be “scrolled” to enable the reviewing of previous events.

In addition to the graph displaying historic data, the built-in data visualization also features a gauge that displays current power usage/generation. In FIG. 2, this is shown on the right side. The width of this gauge has no significance; it just displays momentary total power consumption at the site and amount of power generated locally. Color shading is used to indicate how much more power is used than generated or how much more power is generated than used. However, unlike in the historic data graph, these shaded areas do not represent energies, since the width of the gauge is not related to time.

### Web-Based Configuration and Management

The final part of the web software enables web-based configuration and management of the eGauge devices. To prevent accidental or malicious changes to the device, a user authorizes himself or herself before being allowed to make a change. Critical parameters (such as calibration data), accidental changes to which can lead to a temporary loss of data, require a second level of authorization, which is usually only available to a “super user” who has a strict need for performing such privileged operations.

All aspects of eGauge can be configured through the web interface, including:
The network-interface configuration of eGauge. This includes whether the IP address is obtained dynamically via DHCP or whether a specific, static IP address should be used. Related network parameters such as network info and Domain Name Server (DNS) host names can also be configured.
The host address and port number of the proxy server to use.
Auxiliary information such as the geographic location or time zone in effect at the installation site.
The privacy policy in effect for the eGauge. For example, power-usage data may be password protected. For users without proper authorization, access to power-usage data may either be denied completely or returned at a reduced granularity (e.g., averaged over three hours).
The calibration data.
   As part of the web-based management, the software running on eGauge can also be upgraded via the web. This operation requires authorization to prevent accidental or malicious software upgrades.

### Proxy Software

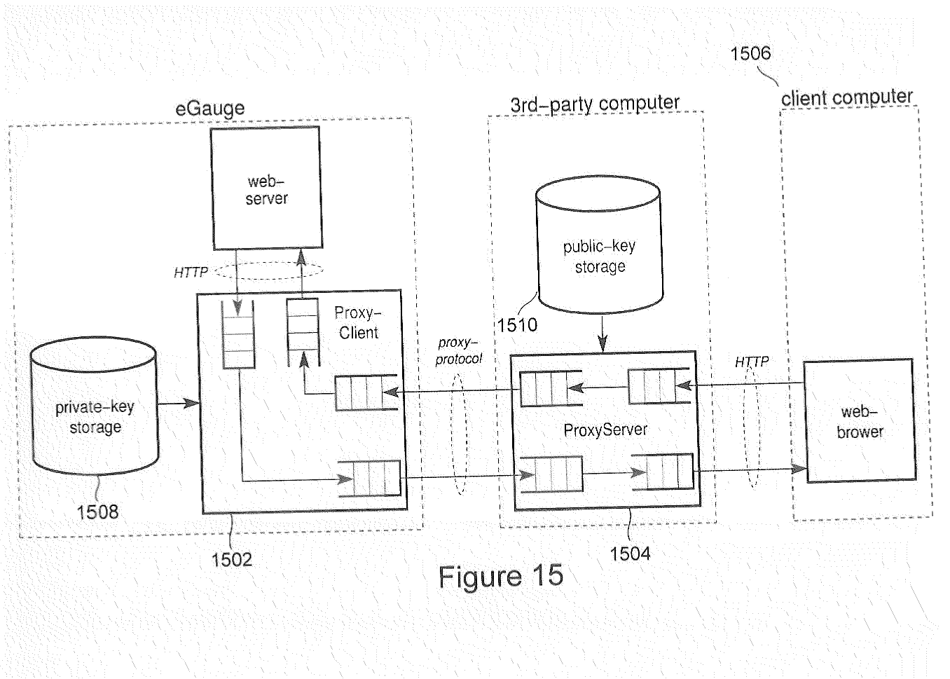

The basic idea behind the proxy software is to make it possible for arbitrary Internet devices to connect to eGauge's web server, even when there may be a firewall present that prevents direct connection to eGauge. FIG. 15 illustrates running a proxy server on a third-party computer according to one embodiment of the present invention. When eGauge powers up, it runs the proxy client 1502, which establishes a connection to the proxy server 1504, identifying itself with a unique configured name (e.g., “egauge15”). Conversely, when the client 1506 wants to access an eGauge, it connects to the proxy server and accesses a special URL which identifies which eGauge is to be accessed. For example, if we assume that the proxy server runs on Internet host www.egproxy.com and listens to such HTTP requests on port 81, then a client could use the following URL to access page/index.html on the eGauge named “egauge15”:
http://egauge15.egproxy.com:81/index.html
   Translating such a URL to its intended target is a two-step process: first, a DNS wildcard resource record is used to translate the domain name egauge15.egproxy.com to the IP address of the host running the proxy. Assuming that address to be 192.168.1.1, this could be accomplished with a DNS resource record of the form:
*IN A 192.168.1.1
   The second step of the translation takes advantage of the virtual host feature defined by HTTP. Specifically, the domain and port number of the server mentioned in the original URL are communicated to the web server via the “Host:” header. In the above example, the “Host:” header might look like this:
Host: egauge15.egproxy.com:81
   The proxy server parses this header before passing it on to the destination web server. In the example of FIG. 15, the proxy server parses this header, finds the component egauge15, and then searches for the proxy client connection of the client who identified itself as “egauge 15.” Note that case is ignored in this matching because IP domain names are case insensitive. Once the proxy server finds the correct proxy client connection, the proxy server forwards the request to the proxy client, which in turn forwards the request to the local web server. When the web server replies, the proxy client forwards the reply to the proxy server, which then forwards it to the client's web browser.

A client can also request a list of proxy clients which are connected to a particular proxy server. The list can be fetched by accessing the/resource on the proxy server. Assuming again a proxy server running at www.egproxy.com, port 81, the list can be requested using URL:
http://www.egproxy.com:81/

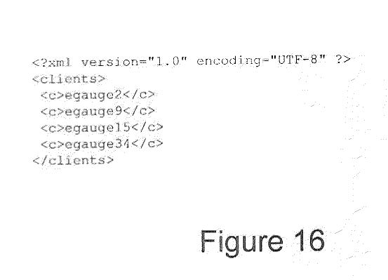

FIG. 16 shows the list returned in an XML format. By returning an XML list, the eGauge proxy server does not need to know anything about the visual formatting conventions used by the web site that provides access to the eGauge clients. Instead, the web site can simply read the XML list and then arbitrarily format the data.

### Proxy Protocol

While the proxy software is transparent in the sense that both the web server running on eGauge and the web browser running on the client computer use standard HTTP to communicate with one another, the protocol between the proxy client and proxy server is rather specialized, although the communication between the proxy client and proxy server does run over a TCP connection.

Note that FIG. 15 is simplified because it shows only a single eGauge and a single client computer. In reality, each proxy server can support multiple eGauges and multiple client computers. Furthermore, each client computer, and even each web browser on a client computer, may issue multiple HTTP requests concurrently. The proxy protocol also needs to take fairness into consideration to prevent, e.g., a single client from blocking others from accessing the proxy server or an eGauge.

Care needs to be taken to properly authenticate proxy clients wanting to connect to a proxy server. Without proper authentication, a site could masquerade under the domain of the proxy server and cause bandwidth or even legal trouble to the owner of the third-party computer. For example, a rogue site could offer pirated movies for download under www.egproxy.com, making it appear as if the owner of www.egproxy.com is actually committing the piracy. Not only could this be problematic from a legal perspective, but it could also lead to massive bandwidth use at the site running www.egproxy.com. To prevent such abuses, the proxy software uses cryptographic authentication. As illustrated in FIG. 15, each eGauge stores a secret private key 1508 and the third-party computer running the proxy server stores a copy of the matching public key 1510 of each proxy client it is allowed to connect to. The exact nature of the authentication protocol used is immaterial, so long as it provides strong authentication to avoid abuses.

Once authenticated, the proxy protocol switches to a packet-oriented protocol with the following format:
addr,port,len|data
   That is, a comma-separated header is followed by a vertical bar character (“|”) which is followed by data. The meaning of the header fields and data follows:
addr: An ASCII-representation of the network address of the client computer that sent or will receive the data in this packet. The address may, for example, be an IPv4 address (e.g., 192.168.1.1), an IPv6 address (e.g., 2001:db8::1428:57ab), or some other format depending on the conventions used by the network used for communication.
port: A decimal ASCII-representation of the number of the port that was used to send or will receive the data in this packet. While the port number is a well-defined entity in the Internet Protocol (IP [4, 15]), the port number in the proxy protocol really can be any number that uniquely identifies the connection end point on the client's computer that sent or will receive the data in this packet.
len: A decimal number specifying the number of bytes in the data portion of the packet.
data: The data constituting the whole or a portion of a request sent by the client's web browser or the whole or a portion of a reply being sent to the client's web browser.
   To ensure fairness, both the proxy server and proxy client serve incoming connections in a round-robin fashion, limit the length of outgoing (transmit) queues to a certain upper bound, and break up incoming (received) data into pieces that are no bigger than a certain upper bound (e.g., 2KiB).

The reliability of the proxy client and its connection to the proxy server is important. Were either to fail, eGauge would not be accessed unless some corrective action were taken at eGauge itself. Since eGauge is installed on customers' premises, this would be costly and disruptive. To prevent this and to maximize reliability, eGauge takes the following steps:
The proxy client may restart itself from time to time. This prevents resource leaks, such as memory leaks, from preventing the proxy client from working properly. The proxy client attempts to do this while idle (no active connections to the web server or proxy server), but when that is not possible, restarts itself forcibly even at the risk of disrupting existing connections. While disrupting connections is not desirable, the effects are commesurate with an Internet site going offline briefly, an occurrence that is not uncommon and hence something that web users are accustomed to deal with.
The proxy client monitors the connection to the proxy server, and when the connection gets dropped or becomes stuck (nothing transmitted within a timeout period when there is pending data), the proxy client immediately attempts to establish a new connection to the proxy server. When that fails, the proxy client periodically attempts to re-establish a connection. The period between connection attempts can be fixed (e.g., once a minute) or with a back off (e.g., 10 seconds, 30 seconds, 1 minute, then every 5 minutes).

Although the present invention has been described in terms of particular embodiments, it is not intended that the invention be limited to these embodiments. Modifications will be apparent to those skilled in the art. For example, the displays may display compiled information for multiple sites within a specified geographical area, for all consumers meeting certain parametric characteristics, and for many other user-specified groups, regions, collections of sites, and other such groups. Displays may display data for multiple different types of consumable entities for a particular installation, site, or region. The hardware and software implementations of various embodiments of the present invention may vary according to varying values of numerous design parameters and implementation parameters.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A monitoring system comprising:
one or more probes for measuring the input of a consumable to, and/or output of a consumable from, a site, installation, home, or region;
a processor that executes programs that receive data from the probes, at intervals in time, and store data representing consumable input and/or output measured by the one or more probes and that store encoded data in one or more electronic memories;
a web server that executes on the processor and that communicates data representing consumable input and/or output to a remote computer or device for storage, processing, analysis, and graphical presentation of the data and results derived from processing and analyzing the data.

2. The monitoring system of claim 1 wherein the data representing consumable input and/or output is stored in a hierarchical and cyclical database within the one or more electronic memories, each hierarchical level of which stores entries containing a measure of consumable input or output over a different, fixed interval of time.

3. The monitoring system of claim 2 wherein the different, fixed interval of time over which consumable input or output is measured for entries of a hierarchical level of the hierarchical and cyclical database is one of:
a fraction of a second;
a second;
a number of seconds less than 60;
a minute;
a number of minutes less than 60;
an hour;
a number of hours less than 24;
a day; and
a number of days.

4. The monitoring system of claim 1 wherein the web server transmits data to remote computers or devices as self-describing XML.

5. The monitoring system of claim 1 wherein the probes measure the input and/or output of one of:
electrical power;
electrical voltage;
electrical current;
a volume of gas;
units of energy of a gas;
a volume of a liquid; and
units of energy of a liquid.

6. The monitoring system of claim 1 wherein the remote computer or device that stores, processes, and analyzes data received from the monitoring system compiles results from data processing and analysis into a graphical presentation provided to a user through a graphical user interface.

7. The monitoring system of claim 6 wherein the graphical presentation includes an indication of consumption of a consumable, as a first color-coded curve, plotted over a period of time and an indication of production of the consumable, as a second color-coded curve, plotted over the period of time.

8. The monitoring system of claim 7 wherein the graphical presentation includes color coding of regions between the first and second color-coded curves to indicate the amounts, over periods of time, by which consumption exceeds production and by which production exceeds consumption.

9. The monitoring system of claim 6 wherein further including an indication of total amounts of a consumable consumed and produced over a period of time.

10. The monitoring system of claim 1 wherein the web server that executes on the processor and that communicates data representing consumable input and/or output to a remote computer or device for storage, processing, analysis, and graphical presentation of the data and results derived from processing and analyzing the data communicates the data through a web proxy implemented on a third-party computer interconnected by the Internet with the remote computer and with the monitoring system.
